(19) United States
(12) Patent Application Publication
(10) Pub. No.: US 2016/0250105 A1
(43) Pub. Date: Sep. 1, 2016

(54) Medication Dispensing Assembly

(71) Applicant: Paul Rogers, JR., Hopkinsville, KY (US)

(72) Inventor: Paul Rogers, JR., Hopkinsville, KY (US)

(21) Appl. No.: 14/632,609

(22) Filed: Feb. 26, 2015

(51) Int. Cl. A61J 7/04

(52) U.S. Cl. CPC A61J 7/0481; A61J 7/0418

(57) ABSTRACT

A medication dispensing assembly includes a housing that has a plurality of wells therein and each of the wells may contain pills. A dispensing unit is coupled to the housing and the dispensing unit may assign a unique user to each of the wells corresponding to the pills contained within each of the wells. The dispensing unit selectively dispenses the pills from each of the wells according to a pre-determined dispensing schedule.

### BACKGROUND OF THE DISCLOSURE

### Field of the Disclosure

The disclosure relates to medication dispensing devices and more particularly pertains to a new medication dispensing device for dispensing medication for a plurality of users over a pre-determined time schedule.

### SUMMARY OF THE DISCLOSURE

An embodiment of the disclosure meets the needs presented above by generally comprising a housing that has a plurality of wells therein and each of the wells may contain pills. A dispensing unit is coupled to the housing and the dispensing unit may assign a unique user to each of the wells corresponding to the pills contained within each of the wells. The dispensing unit selectively dispenses the pills from each of the wells according to a pre-determined dispensing schedule.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a medication dispensing assembly according to an embodiment of the disclosure.

FIG. 2 is a back perspective view of an embodiment of the disclosure.

FIG. 3 is a cross sectional view taken along line 3-3 of FIG. 1 of an embodiment of the disclosure.

FIG. 4 is a front phantom view of an embodiment of the disclosure.

FIG. 5 is a cross sectional view taken along line 5-5 of FIG. 4 of an embodiment of the disclosure.

### DESCRIPTION OF THE PREFERRED EMBODIMENT

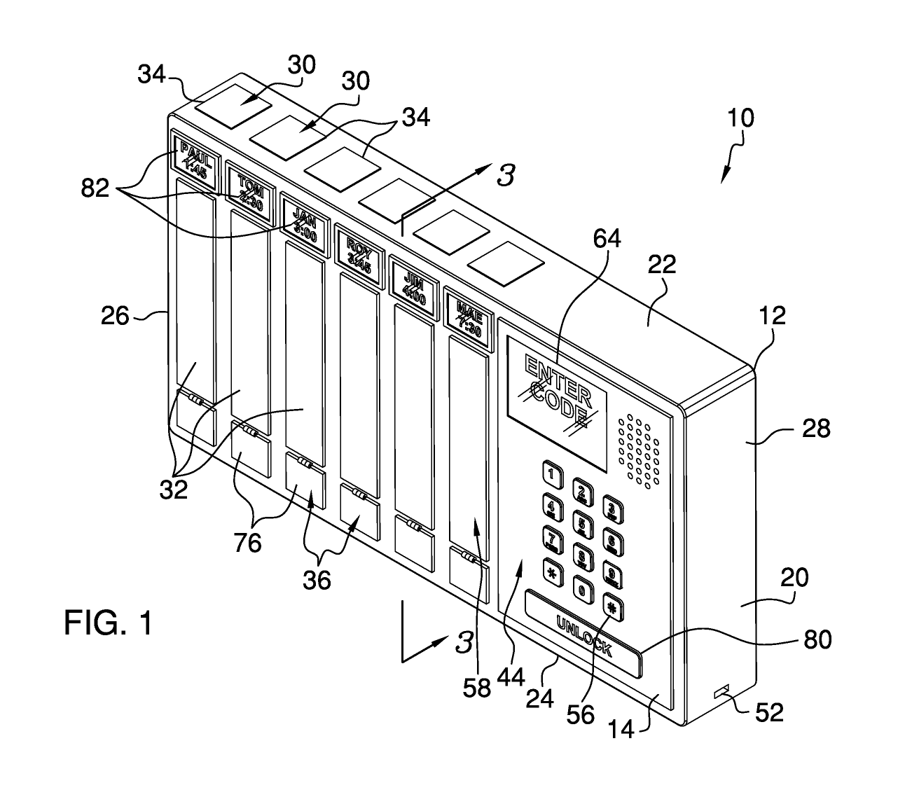

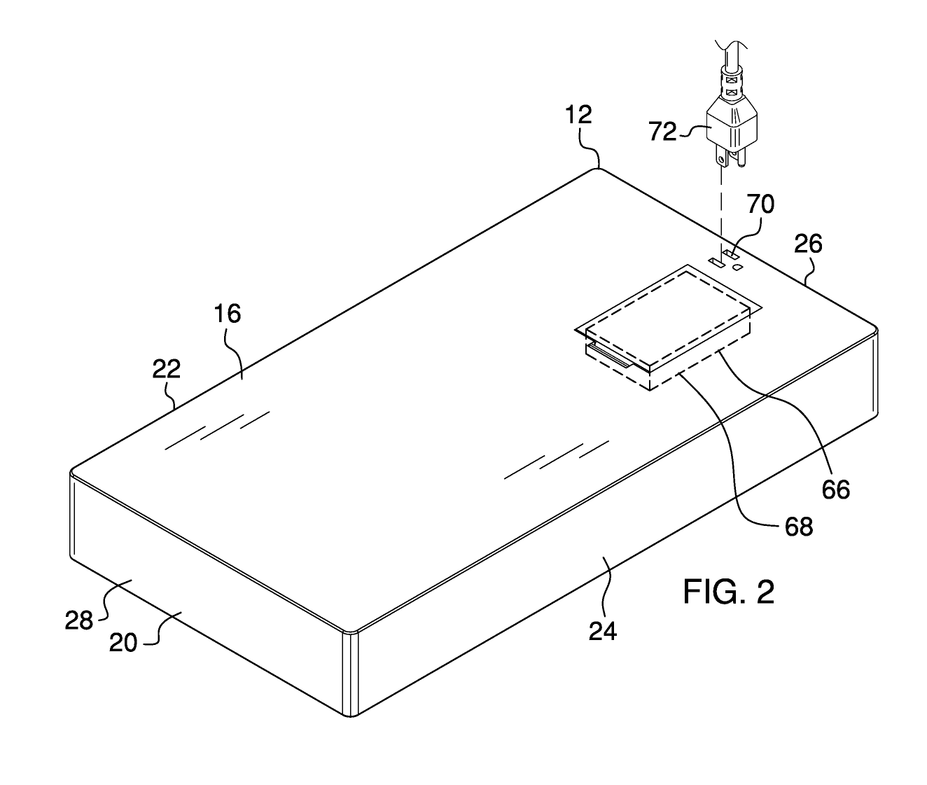

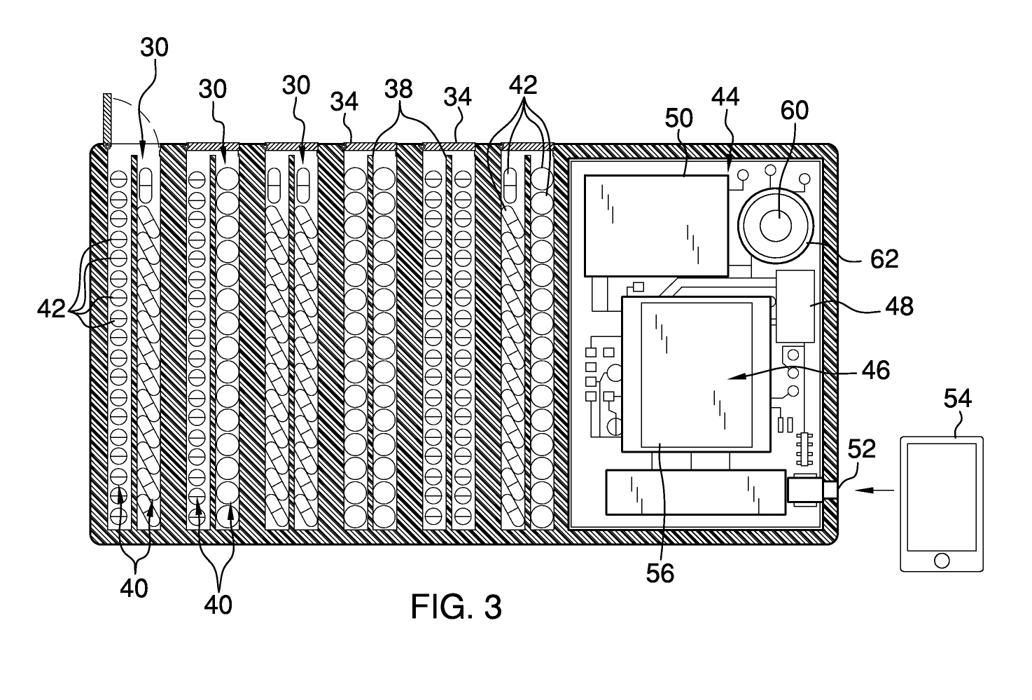

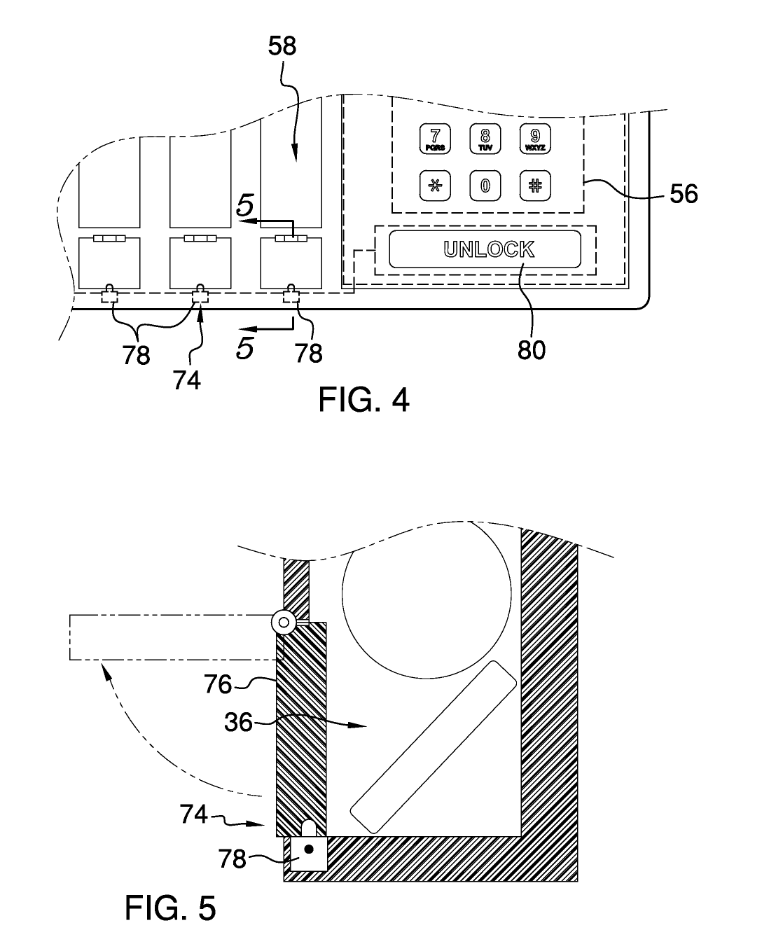

With reference now to the drawings, and in particular to FIGS. 1 through 5 thereof, a new medication dispensing device embodying the principles and concepts of an embodiment of the disclosure and generally designated by the reference numeral 10 will be described.

As best illustrated in FIGS. 1 through 5, the medication dispensing assembly 10 generally comprises a housing 12 that has a front wall 14, a back wall 18 and a peripheral wall 20 extending between the front wall 14 and the back wall 18. The peripheral wall 20 has a top side 22, a bottom side 24, a first lateral side 26 and a second lateral side 28 and the top side 22 has a plurality of wells 30 extending toward the bottom side 24. The wells 30 are spaced apart from each other and are substantially distributed between the first lateral side 26 and the second lateral side 28. The wells 30 may be exposed on the front wall 14 of the housing 12. A plurality of windows 32 may be coupled to the front wall 14 and each of the windows 32 are aligned with one of the wells 30 to allow the wells 30 to be visible. A plurality of covers 34 is provided and each of the covers 34 is removably positioned on the top side 22 to cover the wells 30.

The front wall 14 has a plurality of openings 36 extending therethrough and each of the openings 36 is aligned with and intersects one of the wells 30. The housing 12 has a plurality of dividers 38 and each of the dividers 38 is centrally positioned within and is substantially coextensive with one of the wells 30. Each of the dividers 38 defines a pair of compartments 40 within each of the wells 30 and each of the wells 30 may receive a plurality of pills 42 such that the pills 42 are positionable within each of the compartments 40.

A dispensing unit 44 is coupled to the housing 12 to assign a unique user to each of the wells 30 corresponding to the pills 42 contained within each of the wells 30. The dispensing unit 44 selectively dispenses the pills 42 from each of the wells 30 according to a pre-determined dispensing schedule. The dispensing unit 44 comprises a control unit 46 that is positioned within the housing 12. The control unit 46 comprises a control circuit 48 positioned within the housing 12 and an electronic memory 50 positioned within the housing 12. The electronic memory 50 is electrically coupled to the control circuit 48 and the electronic memory 50 may store audio files and information corresponding to each of the users.

An input 52 is coupled to the housing 12 and the input 52 is electrically coupled to the control circuit 48. The input 52 may be positioned on the second lateral side 28 of the housing. The input 52 may be electrically coupled to an external electronic device 54 to receive the information pertaining to the plurality of users and information pertaining to the pills 42 that are to be taken by each of the users. The input 52 transmits the information to the electronic memory 50. The external electronic device 54 may be a personal computer or the like and the information may include names of the users, the predetermined dispensing schedule for the users to take the pills 42 and other information relating to the proper administering of the pills 42 for the users. The input 52 may comprise a USB port or the like.

A keypad 56 is coupled to the front wall 14 of the housing 12 and the keypad 56 is electrically coupled to the control circuit 48. The keypad 56 is positioned between an innermost one of the wells 58 and the second lateral side 28 and the keypad 56 is engageable to enter one of a plurality of pre-determined pins into the electronic memory 50. Each of the pre-determined pins corresponds to each of the users such that information pertaining to each of the users may be accessed or modified.

A microphone 60 is coupled to the housing 12 and the microphone 60 is electrically coupled to the control circuit 48. The microphone 60 is positioned on the front wall 14 and the microphone 60 may record an audio file and transfer the audio file into the electronic memory 50. The audio file may comprise verbal reminders relating to the users and the pills 42 that need to be taken by the users. A speaker 62 is coupled to the housing 12 and the speaker 62 is electrically coupled to the control circuit 48. The speaker 62 is positioned on the front wall 14 and the speaker 62 audibly emits the audio files stored in the electronic memory 50.

A first display 64 is coupled to the housing 12 and the first display 64 is electrically coupled to the control circuit 48. The first display 64 displays indicia relating to the information contained in the electronic memory 50. The first display 64 may comprise an LCD or the like. A power supply 66 is positioned within the housing 12 and the power supply 66 is electrically coupled to the control circuit 48. The power supply 66 may comprise at least one battery 68. A charge port 70 is coupled to the housing 12 and the charge port 70 is electrically coupled to the power supply 66. The charge port 70 may be electrically coupled to a power source 72 thereby facilitating the power supply 66 to be recharged. The power source 72 may be an electrical outlet or the like.

A releasing unit 74 is coupled to the housing 12 and the releasing unit 74 comprises a plurality of doors 76. Each of the doors 76 is hingedly coupled to the front wall 14 of the housing and each of the doors 76 is positioned over one of the openings 36. Each of the doors 76 is biased into an open position to expose the pills 42 in the wells 30 and each of the doors 76 is positionable in a closed position to close the openings 36.

A plurality of locks 78 is coupled to the housing 12 and each of the locks 78 is electrically coupled to the control circuit 48. Each of the locks 78 engages an associated one of the doors 76 to retain the associated door 76 in the closed position. Each of the locks 78 is selectively actuated to release the associated door 76 such that the associated door 76 is biased into the open position. Thus, a selected number of the pills 42 are removable from the wells 30 covered by the associated door 76. A lock button 80 is coupled to the front wall 14 of housing 12 and the lock button 80 is electrically coupled to the control circuit 48. The lock button 80 is engageable to actuate the locks 78 to release the doors 76 into the open position.

A plurality of second displays 82 is provided and each of the second displays 82 is coupled to the front wall 14 and each of the second displays 82 is electrically coupled to the control circuit 48. Each of the second displays 82 may display indicia indicating one of the user's name and a time the user is to remove the selected number of pills 42 from one of the wells 30. Each of the second displays 82 may be an LCD or the like.

In use, the information pertaining to each of the users is transferred from the external electronic device 54 into the electronic memory 50. Each of the wells 30 is assigned to one of the users and the pills 42 to be taken by each of the users are positioned within the wells 30 assigned to each of the users. Each of the locks 78 releases the associated door 76 into the open position to allow each of the users to remove the pills 42 from the each of the wells 30 assigned to the users. Each of the locks 78 release the associated door 76 into the open position at a time that corresponds with the pre-determined time schedule contained within the electronic memory 50. The lock button 80 is engagable in order to force all of the locks 78 to release the doors 76 into the open position. The speaker 62 may emit a verbal reminder that corresponds to the time schedule for each of the users thereby reminding each of the users to take the pills 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A medication dispensing assembly configured to contain and dispense medication for a plurality of users, said assembly comprising:
a housing having a plurality of wells therein, each of said wells being configured to contain pills, wherein said housing has a front wall, a back wall and a peripheral wall extending between said front wall and said back wall, said peripheral wall having a top side, a bottom side, a first lateral side and a second lateral side, said top side having a plurality of wells extending toward said bottom side, said wells being spaced apart from each other and being substantially distributed between said first lateral side and said second lateral side, wherein said front wall has a plurality of openings extending therethrough, each of said openings being aligned with and intersecting one of said wells, said housing having a plurality of dividers, each of said dividers being centrally positioned within and being substantially coextensive with one of said wells to define a pair of compartments within each of said wells, each of said wells being configured to receive a plurality of pills such that the pills are positionable within each of said compartments;
a dispensing unit coupled to said housing, said dispensing unit being configured to assign a unique user to each of said wells corresponding to the pills contained within each of said wells, said dispensing unit being configured to selectively dispense the pills from each of said wells according to a pre-determined dispensing schedule, wherein said dispensing unit comprises a control unit positioned within said housing, said control unit comprising a control circuit positioned within said housing, an electronic memory positioned within said housing, said electronic memory being electrically coupled to said control circuit, said electronic memory being configured to store audio files and information corresponding to each of the users;
an input coupled to said housing, said input being electrically coupled to said control circuit, said input being configured to be electrically coupled to an external electronic device, said input being configured to receive the information pertaining to the plurality of users and information pertaining to the pills that are to be taken by each of the users, said input being configured to transmit the information to said electronic memory;
a microphone coupled to said housing, said microphone being electrically coupled to said control circuit, said microphone being positioned on said front wall, said microphone being configured to record an audio file and transfer the audio file into said electronic memory.

2. (canceled)

3. (canceled)

4. (canceled)

5. (canceled)

6. The assembly according to claim 1, further comprising a keypad coupled to said front wall of said housing, said keypad being electrically coupled to said control circuit, said keypad being positioned between an innermost one of said wells and said second lateral side, said keypad being engageable to enter one of a plurality of pre-determined pins into said electronic memory, each of said pre-determined pins corresponding to each of the users such that information pertaining to each of the users may be modified.

7. (canceled)

8. The assembly according to claim 1, further comprising a speaker coupled to said housing, said speaker being electrically coupled to said control circuit, said speaker being positioned on said front wall, said speaker being configured to audibly emit the audio files stored in said electronic memory.

9. The assembly according to claim 8, further comprising a first display coupled to said housing, said first display being electrically coupled to said control circuit, said first display displaying indicia.

10. The assembly according to claim 9, further comprising a power supply positioned within said housing, said power supply being electrically coupled to said control circuit, said power supply comprising at least one battery.

11. The assembly according to claim 10, further comprising a charge port coupled to said housing, said charge port being electrically coupled to said power supply, said charge port being configured to be electrically coupled to a power source thereby facilitating said power supply to be recharged.

12. The assembly according to claim 1, wherein:
said housing has a front wall, said front wall having a plurality of openings; and
a plurality of doors, each of said doors being hingedly coupled to said front wall of said housing, each of said doors being positioned over one of said openings, each of said doors being biased into an open position to expose the pills in said wells, each of said doors being positionable in a closed position to close said openings.

13. The assembly according to claim 12, wherein:
said dispensing unit includes a control circuit; and
a plurality of locks coupled to said housing, each of said locks being electrically coupled to said control circuit, each of said locks engaging an associated one of said doors to retain said associated door in said closed position, each of said locks being selectively actuated to release said associated door such that said associated door is biased into said open position thereby facilitating removal of a selected number of the pills from said wells covered by said associated door.

14. The assembly according to claim 13, wherein a lock button coupled to said front wall of housing, said lock button being electrically coupled to said control circuit, said lock button being engageable to actuate said locks to release said doors into said open position.

15. The assembly according to claim 14, wherein said dispensing unit includes a releasing unit coupled to said housing, said releasing unit comprising a plurality of second displays, each of said second displays being coupled to said front wall, each of said second displays being electrically coupled to said control circuit, each of said second displays being configured to display indicia indicating one of the user's name and a time the user is to remove the selected number of pills from one of said wells.

16. A medication dispensing assembly configured to contain and dispense medication for a plurality of users, said assembly comprising:
a housing having a front wall, a back wall and a peripheral wall extending between said front wall and said back wall, said peripheral wall having a top side, a bottom side, a first lateral side and a second lateral side, said top side having a plurality of wells extending toward said bottom side, said wells being spaced apart from each other and being substantially distributed between said first lateral side and said second lateral side, said front wall having a plurality of openings extending therethrough, each of said openings being aligned with and intersecting one of said wells, said housing having a plurality of dividers, each of said dividers being centrally positioned within and being substantially coextensive with one of said wells to define a pair of compartments within each of said wells, each of said wells being configured to receive a plurality of pills such that the pills are positionable within each of said compartments;
a dispensing unit coupled to said housing, said dispensing unit being configured to assign a unique user to each of said wells corresponding to the pills contained within each of said wells, said dispensing unit being configured to selectively dispense the pills from each of said wells according to a pre-determined dispensing schedule, said dispensing unit comprising:
a control unit positioned within said housing, said control unit comprising:
a control circuit positioned within said housing;
an electronic memory positioned within said housing, said electronic memory being electrically coupled to said control circuit, said electronic memory being configured to store audio files and information corresponding to each of the users;
an input coupled to said housing, said input being electrically coupled to said control circuit, said input being configured to be electrically coupled to an external electronic device, said input being configured to receive the information pertaining to the plurality of users and information pertaining to the pills that are to be taken by each of the users, said input being configured to transmit the information to said electronic memory;
a keypad coupled to said front wall of said housing, said keypad being electrically coupled to said control circuit, said keypad being positioned between an innermost one of said wells and said second lateral side, said keypad being engageable to enter one of a plurality of pre-determined pins into said electronic memory, each of said pre-determined pins corresponding to each of the users such that information pertaining to each of the users may be modified;
a microphone coupled to said housing, said microphone being electrically coupled to said control circuit, said microphone being positioned on said front wall, said microphone being configured to record an audio file and transfer the audio file into said electronic memory;
a speaker coupled to said housing, said speaker being electrically coupled to said control circuit, said speaker being positioned on said front wall, said speaker being configured to audibly emit the audio files stored in said electronic memory;
a first display coupled to said housing, said first display being electrically coupled to said control circuit, said first display displaying indicia;
a power supply positioned within said housing, said power supply being electrically coupled to said control circuit, said power supply comprising at least one battery; and
a charge port coupled to said housing, said charge port being electrically coupled to said power supply, said charge port being configured to be electrically coupled to a power source thereby facilitating said power supply to be recharged;
a releasing unit coupled to said housing, said releasing unit comprising:
a plurality of doors, each of said doors being hingedly coupled to said front wall of said housing, each of said doors being positioned over one of said openings, each of said doors being biased into an open position to expose the pills in said wells, each of said doors being positionable in a closed position to close said openings;
a plurality of locks coupled to said housing, each of said locks being electrically coupled to said control circuit, each of said locks engaging an associated one of said doors to retain said associated door in said closed position, each of said locks being selectively actuated to release said associated door such that said associated door is biased into said open position thereby facilitating removal of a selected number of the pills from said wells covered by said associated door;
a lock button coupled to said front wall of housing, said lock button being electrically coupled to said control circuit, said lock button being engageable to actuate said locks to release said doors into said open position; and
a plurality of second displays, each of said second displays being coupled to said front wall, each of said second displays being electrically coupled to said control circuit, each of said second displays being configured to display indicia indicating one of the user's name and a time the user is to remove the selected number of pills from one of said wells.
